(19) United States
(12) Patent Application Publication
(10) Pub. No.: US 2012/0054147 A1
(43) Pub. Date: Mar. 1, 2012

(54) SYSTEM AND METHOD FOR EXTRACT, TRANSFORM, AND LOAD WORKFLOW GENERATION

(76) Inventors: Christophe Goetz, Les adrets de l'Esterel (FR); Bruno Faugeras, Antibes (FR); Christophe Laye, Biot (FR)

(21) Appl. No.: 12/862,956

(22) Filed: Aug. 25, 2010

(51) Int. Cl. G06F 17/30

(52) U.S. Cl. 707/602; 707/E17.005

(57) ABSTRACT

There is provided a computer-executed method of generating an extract, transform, and load (ETL) workflow. The method includes receiving metadata. The metadata describes a mapping between a source and a target, wherein the source and target describe an entity. The method further includes receiving an entity selection that specifies the entity. Additionally, a workflow may be generated based on the metadata and the entity selection. Further, an ETL job may be updated to comprise the generated workflow.

### BACKGROUND

In many organizations, the information technology infrastructure is a collection of heterogeneous systems. For example, an organization might have many different systems that handle client data, employee data, sales data, etc. Typically, these systems are poorly integrated. As a result, even though the information is available in the data systems, the simplest questions, such as “What are the total sales to Customer A?,” can be very hard to answer.

Data warehousing bridges such problems. A data warehouse is a repository of an organization's electronically stored data, typically designed to facilitate reporting and analysis. Data warehousing addresses organizational needs for reliable, relevant, and succinct data.

However, data warehousing does not redesign the data source systems. Instead, data warehousing uses existing system to make data appear consistent, integrated and consolidated despite the underlying source systems.

In addition to data storage, data warehouses retrieve, analyze, extract, transform and load data. Thus, data warehousing may include business intelligence tools, e.g. tools to extract, transform, and load data (ETL tools).

While the processes involved in ETL may be implemented in various ways, building such processes from scratch is typically complex and expensive. Instead, an organization may purchase packaged ETL tools. ETL tools may be used to build and maintain data warehouses, and are typically tailored to interface with various databases and file formats of source systems.

Specially trained ETL developers may design and build data warehouses using ETL tools. While less resource intensive than building from scratch, building ETL systems with ETL tools can still be tedious.

Because ETL jobs are complex, many ETL systems are built using existing jobs as templates for new jobs to build new data warehouses. As such, the ETL developer may use a previously designed ETL system as baseline, customizing the baseline to a new design. However, this approach is still time consuming, error prone, and complex. Additionally, it may be challenging to keep ETL systems designed in this manner in synchronization with evolving source systems. It is also a challenge to keep derived work in synch with evolutions of a baselined design. As understood by one skilled in the art, a design bug found in a baseline, or a template, may only be fixed by manually fixing each ETL derived from the erroneous baseline.

In order to address those issues, generic approaches for implementing data warehouse systems are available. The generic approaches are typically based on a dedicated generic ETL engine. However, typical black box software may only implement a limited set of data warehousing features. As such, design choices typically made when building ETL systems are limited by the features included in the black box software.

### BRIEF DESCRIPTION OF THE DRAWINGS

Certain exemplary embodiments are described in the following detailed description and in reference to the drawings, in which:

FIG. 1 is a block diagram of an ETL model in a system adapted to generate ETL workflows according to an exemplary embodiment of the present invention;

FIG. 2 is a block diagram of an ETL model in a system adapted to generate ETL workflows according to an exemplary embodiment of the present invention;

FIG. 3 is a block diagram of a system adapted to generate ETL workflows according to an exemplary embodiment of the present invention;

FIG. 4 is a block diagram of an ETL system according to an exemplary embodiment of the present invention;

FIG. 5 is a process flow diagram showing a computer-executed method for generating ETL workflows according to an exemplary embodiment of the present invention;

FIG. 6 is a process flow diagram showing a computer-executed method for generating ETL workflows according to an exemplary embodiment of the present invention;

FIG. 7 is a block diagram of a system adapted to generate ETL workflows according to an exemplary embodiment of the present invention;

FIG. 8 is a block diagram of a system adapted to generate ETL workflows according to an exemplary embodiment of the present invention; and

FIG. 9 is a block diagram showing a non-transitory, machine-readable medium that stores code adapted to perform a rowset insert according to an exemplary embodiment of the present invention.

### DETAILED DESCRIPTION

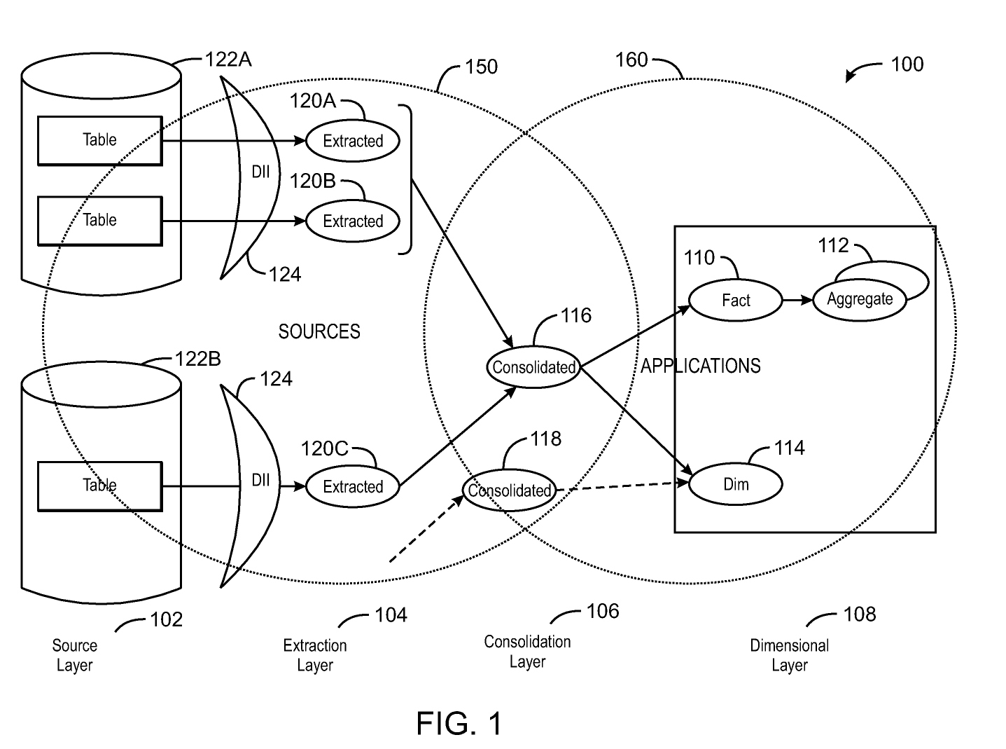

FIG. 1 is a block diagram of an ETL model 100 in a system adapted to generate ETL workflows according to an exemplary embodiment of the present invention. The ETL model 100 may describe the data in each stage of process of extracting, transforming, and loading for a data warehouse. The ETL model 100 may be organized as several layers, with each layer representing a state of the data as the data is processed in each stage of ETL processing. The layers may include a source layer 102, an extraction layer 104, a consolidation layer 106, and a dimensional layer 108.

The circle 150 includes all layers considered as part of the source model, the circle 160 includes all layers considered as part of the application datawarehouse. In the junction of both circles stands the consolidation layer 116, which makes the link between source tables and application datawarehouse tables.

The source layer 102 may describe the data in the source systems. For example, the source layer 102 includes two tables in a data source 122A, and a single table in a data source 122B.

The Data Integration Interface (DII) 124 represents the mechanism by which new data in source tables are regularly collected and do not overlap with data extracted from previous ETL cycles. The Data Integration Interface 124 may implement change data capture. Change data capture may include the incremental extraction of source data. The Data Integration Interface 124 may also isolate ETL from minor source model changes, such as the renaming of source columns.

The extraction layer 104 describes the data after extraction from the data sources 122A, 122B. As shown, the extraction layer 104 includes three extracted data stores 120A, 120B, 120C, one from each of the tables in the data sources 122A, 122B.

The consolidation layer 106 describes the data after being transformed, e.g., consolidated. The consolidation layer 106 includes two data stores 116, 118. As shown in this example, the data store 116 is consolidated from the data stores 120A, 120B, 120C of the extraction layer 104. The data store 118 may be consolidated from a source system that is external to the organization.

The dimensional layer 108 may describe the data stored in the repository of the data warehouse. Typically, the repository of the data warehouse includes dimensions 114, fact 110, and aggregate 112 tables. These tables are typically configured for the reporting performed on the data warehouse.

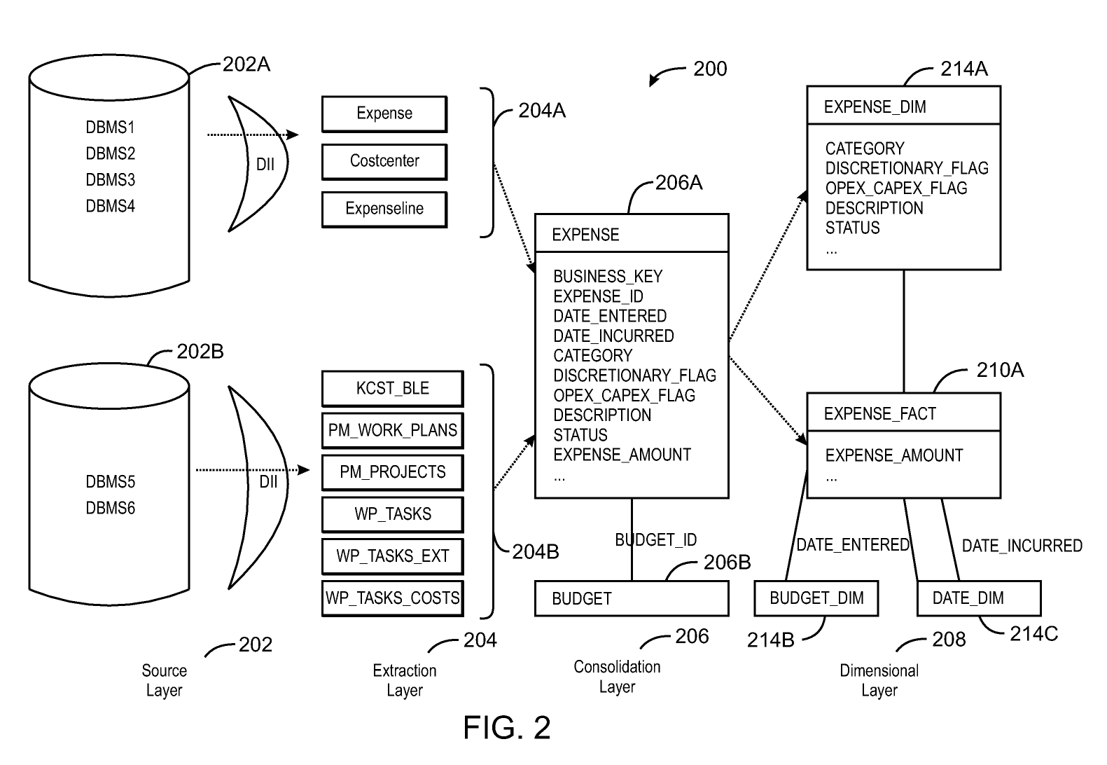

FIG. 2 is a block diagram of an ETL model 200 in a system adapted to generate ETL workflows according to an exemplary embodiment of the present invention. The source layer 202 includes two data sources 202A, 202B, which include DBMSs 1-4, and DBMSs 5-6, respectively. The DII 224 extracts the data in data stores 204A and 204B from the data sources 202A, 202B.

In this example, the data store 204A includes data from database tables labeled, EXPENSE, COSTCENTER, and EXPENSELINE. The data store 204B may include columns from various tables in the data source 202B.

The consolidation layer 206 includes an EXPENSE table, which, as shown, has a relationship to a table labeled BUDGET. As shown, all data in the extraction layer 204 is consolidated into the EXPENSE table. The BUDGET_ID may represent a unique identifier for rows in the BUDGET table.

The dimensional layer 208 includes one fact table 210A, with relationships to three dimensional tables 214A, 214B, 214C. The DATE_ENTERED and DATE_INCURRED may represent unique identifiers for the BUDGET_DIM 214B and DATE_DIM 214C tables, respectively. As shown, the EXPENSE_DIM 214A and the EXPENSE_FACT 210A may be populated with data from the EXPENSE 206A of the consolidation layer 206.

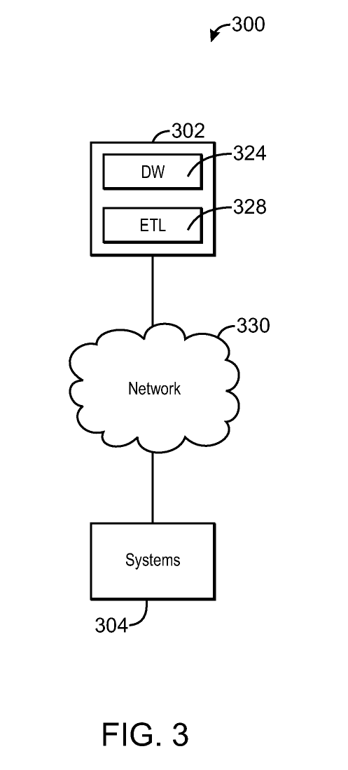

FIG. 3 is a block diagram of a system adapted to generate ETL workflows according to an exemplary embodiment of the present invention. The system 300 includes a data warehousing system 302 connected over a network 330 to source systems 304. The source systems 304 provide the data stored in the repository of a data warehouse (DW) 324.

The data warehousing system 302 comprises the data warehouse 324 and an ETL system 328. The ETL system 328 may extract data from the source systems 304, transform the data, and load the transformed data into the data warehouse repository.

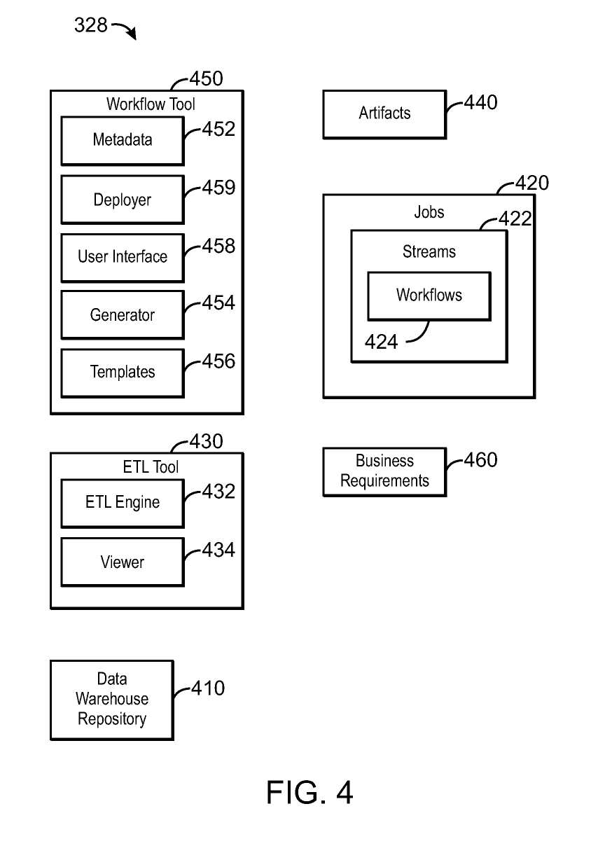

FIG. 4 is a block diagram of an ETL system according to an exemplary embodiment of the present invention. The ETL system 328 may include a data warehouse repository 410, ETL jobs 420, an ETL tool 430, ETL artifacts 440, a workflow tool 450, and business requirements 460.

The data warehouse repository 410 may be a repository of database tables that are populated with consolidated data that is initially extracted from source systems (not shown). Each of the ETL jobs 420 may perform one of the extraction, transformation, or loading steps of the ETL process for the data warehouse repository 410.

The ETL jobs 420 may include ETL streams 422, which may include ETL workflows 424. The ETL workflows 424 may perform a task for a particular data entity, e.g., transforming extracted data into a consolidated version of the data. The ETL workflow 424 may, for example, convert extracted sales data into consolidated quarterly profits data. In one embodiment of the invention, the workflows 424 may reference one or more artifacts 440, described in greater detail below.

Data entities may be specific organizations of data in the source systems and the data warehouse repository 410. The different organizations may represent perspectives, or views of the source data. As understood by one of ordinary skill in the art, many different entity types are possible. For example, a business organization may have entity types, such as projects, customers, costs, and the like.

Typically, each of the ETL jobs 420 is performed simultaneously for all entities. In some cases, simultaneous processing may be useful because of database constraints. For example, dimension and fact tables in the data warehouse repository 410 may be populated with surrogate keys for existing rows during a database load.

Each ETL stream 422 may be a collection of several ETL workflows 424. Individual ETL streams 422 may be entity specific, or entity agnostic. Entity specific ETL streams 422 may only include ETL workflows 424 that process a specified entity. Entity agnostic ETL streams 422 may include ETL workflows 424 that collectively process numerous entities.

The ETL jobs 420 may be generated and executed through the use of the ETL tool 430. The ETL tool 430 may include an ETL engine 432, and an ETL viewer 434. The ETL engine 432 may be a process that manages the execution of the ETL jobs 420 on a periodic basis (typically every night).

The ETL viewer 434 may be used by ETL developers to specify mappings between the different formats of data in each of the ETL jobs 420. Based on these specifications, the ETL tool 430 may generate ETL artifacts 440.

The ETL artifacts 440 may specify schemas of data transformations from source to extracted, extracted to transformed, and transformed to consolidated data. The ETL artifact 440 may be a module that is proprietary to the ETL tool 430.

In an exemplary embodiment of the invention, the workflow tool 450 may also generate ETL artifacts 440 that may be used by the ETL tool 430. Advantageously, the ETL artifacts 440 generated by the workflow tool 450 may be viewed and modified using the ETL viewer 434.

The workflow tool 450 may include metadata 452, a generator 454, templates 456, a workflow user interface (UI) 458, and a deployer 459. The metadata 452 may include schemas, attributes, and relationships for each layer of the ETL model 200. The metadata may also include mappings between the layers. In an exemplary embodiment of the invention, the mappings may even include native SQL expressions.

The metadata 452 may describe the ETL model 100, which may be specified in terms of entities. Within the metadata 452, an entity usually consists of several source tables, one consolidation table, and several dimension/facts tables.

The metadata 452 may be specified and viewed in the workflow user interface 458. The workflow user interface 458 may also validate the metadata 452. Validation may include ensuring that all attributes specified in the metadata 452 are defined, used, etc.

The templates 456 may be entity-independent files in the format of the artifacts 440 for a specific ETL tool 430. The templates 456 may be derived from the modification of existing artifacts 440. The artifacts 440 may be modified by replacing entity-specific references, e.g., entity names, lists of attributes, etc., with programmatic calls to be later filled in by the generator 454.

The templates 456 may be used by the generator 454 to generate artifacts 440, and their corresponding workflows 424, for specific entities. For example, by turning an artifact 440 for a “customer” entity into a template 456, the same transformations specified in that artifact 440 can be replicated in a new artifact 440 for another entity, such as “costs.”

When generating new artifacts 440, the user may specify one or more entities, one or more layers of the ETL model 200, or the entire ETL model 200. Additionally, new versions of artifacts 440 may be generated whenever the metadata 452 is updated for a particular entity, e.g., adding/changing attributes, etc.

The generator 454 may process the metadata 452 for specified entities to determine a pattern. The patterns may be determined through relationships described between layers of data in the ETL model 100. Patterns may identify the configuration of sources and targets used in the processing of the workflows 424.

Different patterns may vary with regard to how sources are configured, e.g., single tables within multiple databases, multiple tables within a single database, or multiple tables in each of multiple databases. Patterns may be similarly varied with regard to target configurations. For example, one pattern may be the use of a single source, e.g., a single source table from a single database, to be loaded into a target, such as multiple tables in a single database. Another pattern may be for the use of multiple source tables in multiple databases to be loaded into a single table in a single database.

The generator 454 may be a command line, or other executable process on a computing system. The generator 454 may produce ETL workflows and the deployer 459 may update ETL jobs to incorporate generated ETL workflows in ETL jobs. The generator 454 may produces files in predefined output folders. In an embodiment of the invention, the ETL designer may not be allowed to rename generated folders nor generated files. In one embodiment of the invention, the generation or updating of ETL jobs 420 may be automated once the ETL templates 456 and the metadata 452 are defined.

The generator 454 takes in charge their packaging (based on convention rather than configuration). As understood by one skilled in the art, convention over configuration is a design pattern related to “Don't Repeat Yourself: (DRY) principles. The goal is to avoid generating a configuration file describing where the artifacts 440 to integrate are located.

Simply delivering the artifacts 440 in specific folders helps the system to find the artifacts 440, and manage their content. Such principles are often used for example by modern web frameworks (RoR, grails, . . . ) to address the configuration complexity that may result from the huge number of software pieces involved in an MVC layered solution.

In one embodiment of the invention, the generator 454 may assemble the generated workflows 424 into consistent ETL jobs 420 that may be executed, controlled, and monitored as a sequence of ETL steps. In such an embodiment, a system to monitor execution of the ETL jobs 420 may be included in the workflows 424.

The monitoring system may be agnostic to the ETL tool 430. In other words, the monitoring system may not be dependent upon the ETL tool 430, and may present an ETL dashboard that is consistent across vendors of various ETL tools 430.

The deployer 459 may generate the ETL workflows 424 based on the artifacts 440. Additionally, the deployer 459 may update the ETL jobs 420 to incorporate new/modified ETL workflows 424.

The deployer 459 may load the workflows 424 corresponding to generated artifacts 440 into an appropriate ETL job 420. In an exemplary embodiment of the invention, the generator 454 may generate an XML file that specifies the ETL job 420 to be updated with the new ETL workflow 424. The XML file may also specify where in the ETL job 420 the workflow 424 is to be plugged. In such an embodiment, the deployer 459 may update the ETL jobs 420 according to the specifications of the XML file.

The business requirements 460 may specify parameters about the implementation environment of the ETL system 420. Parameters may include details such as the operating system, database software, the ETL tool n, data warehousing software, etc. The ETL system 420 may use the business requirements to generate, modify, implement, and execute the ETL jobs 420.

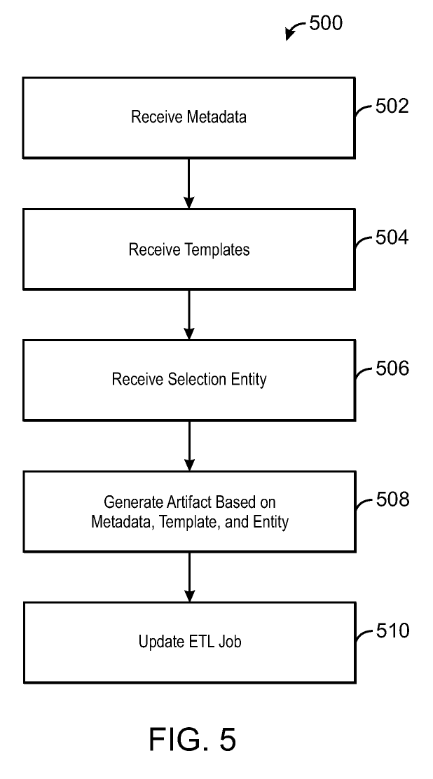

FIG. 5 is a process flow diagram showing a computer-executed method 500 for generating ETL workflows according to an exemplary embodiment of the present invention. The method is generally referred to by the reference number 500, and may be performed by the workflow tool 450. It should be understood that the process flow diagram is not intended to indicate a particular order of execution.

The method 500 begins at block 502, where the workflow tool 450 may receive the metadata 452. As stated previously, the ETL developers may specify the metadata 452 with the workflow user interface 458.

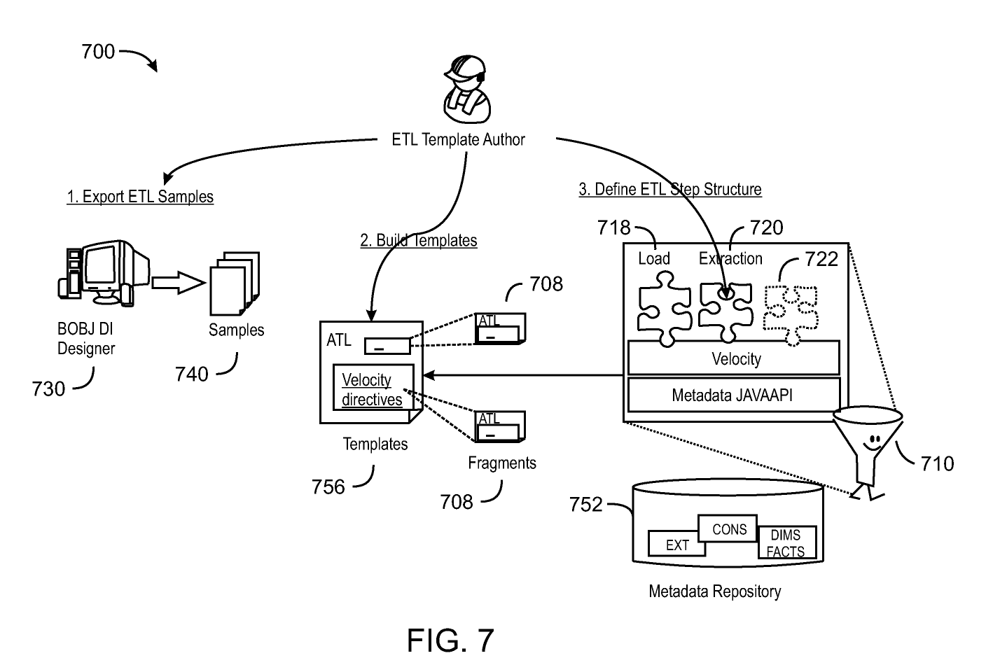

At block 504, the workflow tool 450 may receive the templates 536. The block 504 is described with reference to FIG. 7, which is a block diagram of a system adapted to generate ETL workflows according to an exemplary embodiment of the present invention.

As shown, an ETL template author may export samples 740 from a Third Party vendor ETL job designer such as Business Object Data Integration designer BOBJ DI designer 730. The ETL template author may be an ETL developer, or another user of the ETL tool 430. The samples 740 may be existing artifacts 440 generated by the ETL tool 430 or the workflow tool 450. The ETL template author may then build templates 756 from the samples 740.

In an exemplary embodiment of the invention, the templates 756 may include several fragments 708. Each fragment 708 may address individual, atomic transformations. Atomic transformations may include, for example, resolving surrogate keys, filling intermediate tables, altering attribute values per a specified business rule, merging attributes, and the like. Having the template 756 consist of fragments 708 may enable the workflow tool 450 to isolate transformations and create new versions of the templates 756. In templates 756 involving a great number of transformations, isolating each transformation in a fragment 708 may facilitate the quick and efficient identification of the fragment 708 to adapt when a specific transformation must be changed.

As stated previously, the templates 456 may be entity-independent versions of artifacts 440. Accordingly, the ETL template author may replace the entity-specific information in the samples 740 with programmatic calls to be filled in by the generator 710.

The ETL template author may also define an ETL step structure, which defines how ETL individual generated workflows should integrate within the various ETL jobs. The templating technology on 756 is based on velocity framework through velocity directives. The generator 710 interprets velocity directives to build entity specific ETL workflows.

The ETL template author may also specify conditions for which the template 756 is to be used. For example, the ETL template author may specify that the template 756 is to be used for entities with a pattern of multiple source tables in multiple source databases, to be loaded into a single table in a single database.

Referring back to FIG. 5, at block 506, the workflow tool may receive an entity selection. The entity selection may be included in a request from the ETL developer to generate an ETL workflow 424. As stated previously, using the workflow user interface 158, the ETL developer may trigger the workflow generation.

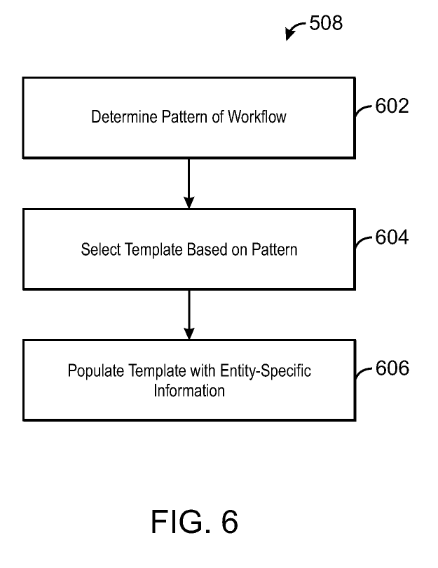

At block 508, the workflow tool 450 may generate an artifact 440 based on the metadata 452, the templates 456, and the entity selection. As stated previously, the workflow tool 450 may generate a specification for the artifact 440, such as an XML file. The specification may describe how to modify one of the ETL jobs 420 to incorporate the workflow 424 corresponding to the newly generated artifact 440. The block 508 is described in greater detail with reference to FIG. 6.

At block 510, the workflow tool 450 may update the ETL job 420. The workflow tool 450 may generate the workflow 424 corresponding to the newly generated artifact 440. Additionally, based on the XML specification, one of the ETL jobs 420 may be updated to execute the newly generated workflow 424.

FIG. 6 is a process flow diagram showing a computer-executed method 600 for generating ETL workflows according to an exemplary embodiment of the present invention. The method is generally referred to by the reference number 600, and may be performed by the generator 454. It should be understood that the process flow diagram is not intended to indicate a particular order of execution.

The method 600 begins at block 602, where the generator 454 may determine a pattern. The pattern may be determined based on the entity selection. In an exemplary embodiment of the invention, the generator 454 may analyze the relationships between the various layers of data for the entity selected. Based on the relationships, the generator 454 may determine a pattern.

At block 604, the generator 454 may select a template 456 based on the pattern. As stated previously, the template 456 may be an entity-independent artifact 440.

At block 606, the generator 454 may populate the template 456 with entity-specific information for the selected entity. The populated template may be an artifact 440 that can be viewed and updated using the ETL tool 430.

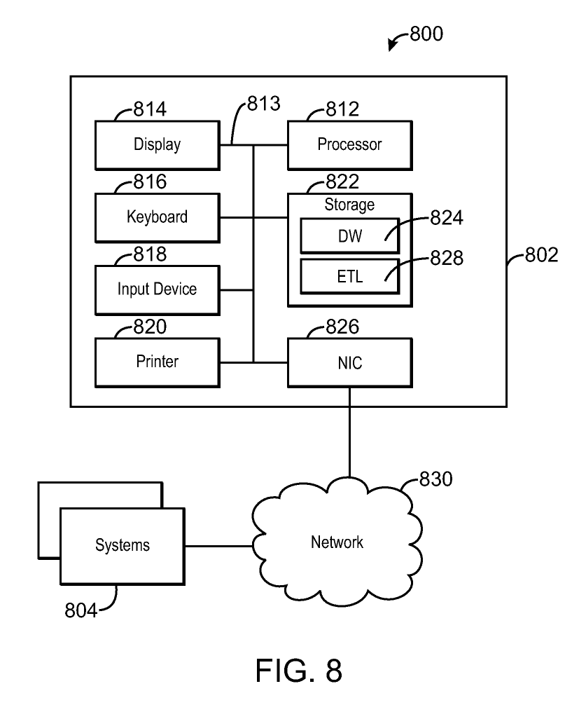

FIG. 8 is a block diagram of a system adapted to generate ETL workflows according to an exemplary embodiment of the present invention. The system is generally referred to by the reference number 800. Those of ordinary skill in the art will appreciate that the functional blocks and devices shown in FIG. 8 may comprise hardware elements including circuitry, software elements including computer code stored on a non-transitory, machine-readable medium or a combination of both hardware and software elements.

Additionally, the functional blocks and devices of the system 800 are but one example of functional blocks and devices that may be implemented in an exemplary embodiment of the present invention. Those of ordinary skill in the art would readily be able to define specific functional blocks based on design considerations for a particular electronic device.

The system 800 may include a data warehouse server 802, and one or more source systems 804, in communication over a network 830. As illustrated in FIG. 8, the data warehouse server 802 may include a processor 812 which may be connected through a bus 813 to a display 814, a keyboard 816, one or more input devices 818, and an output device, such as a printer 820. The input devices 818 may include devices such as a mouse or touch screen.

The data warehouse server 802 may also be connected through the bus 813 to a network interface card (NIC) 826. The NIC 826 may connect the database server 802 to the network 830. The network 830 may be a local area network (LAN), a wide area network (WAN), such as the Internet, or another network configuration. The network 830 may include routers, switches, modems, or any other kind of interface device used for interconnection.

Through the network 830, several source systems 804 may connect to the data warehouse server 802. The source systems 804 may be similarly structured as the data warehouse server 802, with exception to the storage 822. In an exemplary embodiment, the source systems 804 may house the data that is consolidated and stored in the data warehouse 824.

The data warehouse server 802 may have other units operatively coupled to the processor 812 through the bus 813. These units may include non-transitory, machine-readable storage media, such as a storage 822. The storage 822 may include media for the long-term storage of operating software and data, such as hard drives. The storage 822 may also include other types of non-transitory, machine-readable media, such as read-only memory (ROM), random access memory (RAM), and cache memory. The storage 822 may include the software used in exemplary embodiments of the present techniques.

The storage 822 may include the data warehouse 824 and an ETL system 828. As stated previously, the data warehouse 824 may include various software systems for consolidating and storing organizational data from the source systems 804.

The ETL system 828 may be a software system that can be customized for the organization to extract data from the source systems 804, transform the data according to organizational specifications, and load the data into the data warehouse 824.

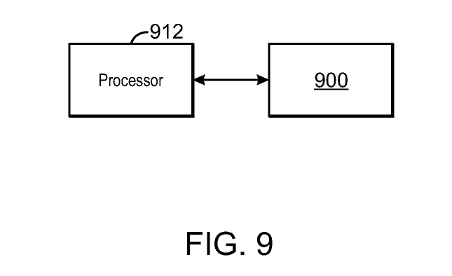

FIG. 9 is a block diagram showing a non-transitory, machine-readable medium that stores code adapted to generate an ETL workflow according to an exemplary embodiment of the present invention. The non-transitory, machine-readable medium is generally referred to by the reference number 900.

The non-transitory, machine-readable medium 900 may correspond to any typical storage device that stores computer-implemented instructions, such as programming code or the like. For example, the non-transitory, machine-readable medium 900 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices.

A processor 902 generally retrieves and executes the computer-implemented instructions stored in the non-transitory, machine-readable medium 900 to generate ETL workflows 424. Metadata about entities in a data warehouse may be generated. Templates that specify generic transformations of data may also be generated. An entity selection specifying an entity may be received. The template may be identified based on a pattern of the entity. A workflow may be generated based on the metadata, the template, and the entity selection. An ETL job may be updated to comprise the workflow, and then executed.

What is claimed is:

1. A computer-executed method of generating an extract, transform, and load (ETL) workflow, comprising:
receiving metadata that describes a mapping between a source and a target, wherein the source and target describe an entity;
receiving an entity selection that specifies the entity;
generating a workflow based on the metadata and the entity selection; and
updating an ETL job to comprise the generated workflow.

2. The method recited in claim 1, comprising performing the ETL job, wherein the source is transformed to the target, wherein the ETL job is performed by an ETL engine of an ETL tool.

3. The method recited in claim 1, comprising:
identifying a pattern for the entity based on the metadata;
selecting a template for transforming the source to the target, based on the pattern;
generating an artifact based on the template and the metadata, wherein the artifact is configurable by an ETL tool; and
generating and integrating the artifact into an overall ETL workflow

4. The method recited in claim 3, wherein the pattern comprises one of:
a plurality of source tables, in a plurality of source databases;
the plurality of source tables, in a single source database; and
a singular source table, in the single source database.

5. The method recited in claim 4, wherein the pattern comprises one of:
a plurality of target tables, in a plurality of target databases;
the plurality of target tables, in a single target database; and
a singular target table, in the single target database.

6. The method recited in claim 3, comprising:
modifying the artifact with the ETL tool;
generating the ETL workflow based on the modified artifact; and
saving one or more modifications of the modified artifact.

7. The method recited in claim 3, comprising generating the template by removing entity-specific information from the artifact.

8. The method recited in claim 3, wherein the artifact is proprietary to the ETL tool.

9. The method recited in claim 1, wherein the entity selection specifies one of:
an ETL model, wherein the metadata describes the ETL model; and
a layer of the ETL model.

10. The method recited in claim 1, comprising specifying:
the ETL job; and
a location within the ETL job where the ETL workflow is inserted.

11. The method recited in claim 10, comprising generating an XML file that specifies the ETL job and the location.

12. The method recited in claim 1, comprising generating a monitoring system for the ETL job, wherein the monitoring system is agnostic to the ETL tool, and wherein the monitoring tool displays an ETL dashboard, wherein the ETL dashboard displays information about an execution of the ETL job.

13. A computer system for generating an extract, transform, and load (ETL) workflow, the computer system comprising a processor configured to:
receive metadata that describes a mapping between a source and a target, wherein the source and target describe an entity;
receiving an entity selection that specifies the entity;
generate a plurality of workflows for an ETL tool, based on the metadata and the entity; and
assemble the plurality of workflows into an ETL job comprising a monitoring system, wherein the ETL job can be executed by an ETL engine of the ETL tool.

14. The computer system recited in claim 13, wherein the processor is configured to execute the ETL job using the ETL engine of the ETL tool.

15. The computer system recited in claim 13, wherein the processor is configured to:
identify a pattern for the entity based on the metadata;
select a template for transforming the source to the target, based on the pattern; and
generate an artifact based on the template and the metadata, wherein the artifact is configurable by the ETL tool.

16. The computer system recited in claim 15, wherein the processor is configured to:
modify the artifact with the ETL tool;
generate the ETL workflow based on the modified artifact; and
save one or modifications of the modified artifact.

17. The computer system recited in claim 15, wherein the artifact is proprietary to the ETL tool.

18. The computer system recited in claim 13, wherein the processor is configured to generate an XML file that specifies an assembly of the plurality of workflows in the ETL job.

19. The computer system recited in claim 13, wherein the monitoring system comprises a display of an ETL dashboard, wherein the ETL dashboard displays information about an execution of the ETL job.

20. A non-transitory, machine-readable medium that stores code adapted to generate an extract, transform, and load (ETL) workflow, comprising machine-readable instructions that, when executed by a processor, causes the processor to:
implement a template;
generate metadata;
receive an entity selection specifying an entity;
identify the template based on a pattern of the entity;
generate a workflow based on the metadata, the template, and the entity selection;
update an ETL job comprising the workflow; and
execute the ETL job.
